(19) United States
(12) Patent Application Publication
(10) Pub. No.: US 2025/0001734 A1
(43) Pub. Date: Jan. 2, 2025

(54) POLYIMIDE ADHESIVE COMPOSITION COMPRISING MALEIMIDE MOIETIES AND AMINE COMPOUND, ARTICLES AND METHODS

(71) Applicant: 3M INNOVATIVE PROPERTIES COMPANY, St. Paul, MN (US)

(72) Inventors: Ralph R. Roberts, Oakdale, MN (US); Claire Hartmann-Thompson, Lake Elmo, MN (US); Gregory P. Sorenson, Maplewood, MN (US); Erik M. Townsend, South St. Paul, MN (US); Mario A. Perez, Wellington, FL (US)

(21) Appl. No.: 18/820,612

(22) Filed: Aug. 30, 2024

Related U.S. Application Data
(63) Continuation-in-part of application No. PCT/IB2023/059038, filed on Sep. 12, 2023.
(60) Provisional application No. 63/407,299, filed on Sep. 16, 2022.

(51) Int. Cl. B32B 15/092; B32B 7/12; B32B 37/12; B32B 37/16

(52) U.S. Cl. CPC B32B 15/092; B32B 7/12; B32B 37/12; B32B 37/16; B32B 2037/1253; B32B 2307/302; B32B 2307/304; B32B 2307/538; B32B 2311/12; B32B 2313/02; B32B 2315/08; B32B 2315/16; B32B 2363/00

(57) ABSTRACT

Adhesive compositions, articles, and methods are described. The electronic may comprise: i) a conductive metallic substrate; ii) an insulating resin layer; and iii) and an adhesive layer disposed between the substrate and insulating resin layer. The adhesive layer comprises at least 50 wt. % of polyimide resin comprising maleimide moieties; and at least 0.25 wt. % of an amine compound. In some embodiments, the conductive metallic substrate comprises copper, such as copper traces.

### SUMMARY

Multilayer printed circuit boards (PCB's) are typically constructed from a conductive layer such as one containing copper with non-conductive (i.e., insulating) layers such as a partially cured B-stage (e.g., epoxy) resin, i.e., a prepreg. Such a multi-layer sandwich is bonded together by applying heat and pressure. The conductive layer, e.g., copper circuitry, does not bond well to the non-conductive B-stage resin prepreg.

In one embodiment, an electronic article is described comprising: i) a conductive metallic substrate; ii) an insulating resin layer; and iii) and an adhesive layer disposed between the substrate and insulating resin layer. The adhesive layer comprises at least 50 wt. % of polyimide resin comprising maleimide moieties; and at least 0.25 wt. % of an amine compound. In some embodiments, the conductive metallic substrate comprises copper, such as copper traces.

The polyimide typically has the formula:

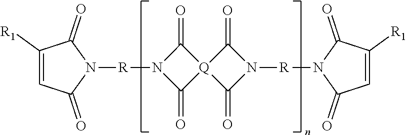

where R¹ is hydrogen or methyl; and Q and R are independently organic linking groups.

Also described are components of an electronic article comprising i) and iii) or ii) and iii), as described above.

In another embodiment, an adhesive composition is described comprising: at least 50 wt. % of polyimide resin comprising maleimide moieties; and at least 0.25 wt. % of an amine compound comprising two or more amine groups.

In another embodiment, a method of bonding is described comprising:
providing a conductive metallic substrate; providing an insulating resin layer;
providing an adhesive layer, as described above, between the substrate and insulating resin layer.

### BRIEF DESCRIPTION OF THE DRAWINGS

FIG. 1 is a cross-section of a two-layer article;

FIG. 2 is a cross-section of a three-layer article;

FIG. 3 is a cross-section of a portion of an integrated chip 300;

FIG. 4 depicts a cross-section of the configuration prepared to test the peel strength of the adhesive (i.e. bonding film) to copper.

### DETAILED DESCRIPTION OF THE DRAWINGS

Polyimide with Maleimide Moieties

The adhesive composition comprises a polyimide comprising maleimide moieties. Polyimides comprise imide groups, —O═C—N—C═O—, in the polymer backbone. The maleimide moieties have the following formula.

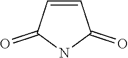

The polyimide may be described as a maleimide terminated polyimide. Such a polyimide may have the following Formula 1:

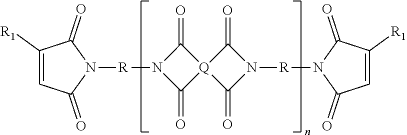

wherein R₁ is hydrogen or methyl; and
and Q and R are independently organic linking groups.
Q and R are typically independently an aliphatic, cycloaliphatic, alkenyl, aromatic, or heteroaromatic group. Such a group may be substituted or unsubstituted.

In some embodiments, Q is a (e.g. a tetravalent) aromatic group.

The maleimide terminated polyimides are derived from the reaction of a diamine with an acid dianhydride. The R group is typically the reaction product of one or more diamines.

Suitable diamines include for example 4,4′-methylenebis(2,6-diethylaniline); tricyclodecane diamine (TCD-diamine); bisaniline-P; 2.2-bis [4-(4-aminophenoxy)phenyl] hexafluoropropane; 1, 10-diaminodecane; 1,12-diaminododecane; dimer diamine; hydrogenated dimer diamine; 1,2-diamino-2-methylpropane; 1,2-diaminocyclohexane; 1,2-diaminopropane; 1,3-diaminopropane; 1,4-diaminobutane; 1,5-diaminopentane; 1,7-diaminoheptane;1,8-diaminomenthane; 1,8-diaminooctane; 1,9-diaminononane; 3,3′-diamino-N-methyldipropyl amine; diaminomaleonitrile; 1,3-diaminopentane; 9, 10-diaminophenanthrene; 4,4′-diaminooctafluorobiphenyl; 3,5-diaminobenzoic acid; 3,7-diamino-2-methoxyfluorene; 4,4′-diaminobenzophenone; 3,4-diaminobenzophenone; 3,4-diaminotoluene; 2,6-diaminoanthroquinone; 2,6-diaminotoluene; 2,3-diaminotoluene; 1,8-diaminonaphthalene; 2,4-diaminotoluene; 2,5-diaminotoluene; 1,4-diaminoanthroquinone; 1,5-diaminoanthroquinone; 1,5-diaminonaphthalene; 1,2-diaminoanthroquinone; 2,4-cumenediamine; 1,3-bisaminomethyl benzene; 1,3-bisaminomethylcyclohexane; 2-chloro-1,4-diamino benzene; 1,4-diamino-2,5-dichloro benzene; 1, 4-diamino-2, 5-dimethyl benzene; 4, 4′-diamino-2,2′-bistrifluoromethyl biphenyl; bis(amino-3-chlorophenyl)ethane; bis(4-amino-3,5-dimethylphenyl)methane; bis(4-amino-3,5-diisopropylphenyl)methane; bis(4-amino-3,5-methyl-isopropylphenyl) methane; bis(4-amino-3,5-dieth lphenyl)methane; bis(4-amino-3-ethyl phenyl)methane; diaminofluorene; 4, 4′-(9-fluorenylidene)dianiline; diaminobenzoic acid; 2,3-diaminonaphthalene; 2,3-diaminophenol;-5-methylphenyl)methane; bis(4-amino-3-methylphenyl)methane; bis(4-amino-3-ethylphenyl)methane; 4, 4′-diaminopheny lsulfone; 3,3′-diaminophenyl sulfone; 2,2-bis(4,-(4-aminophenoxy)phenyl)sulfone; 2,2-bis(4-(3-aminophenoxy)phenyl)sulfone; 4,4′-oxydianiline; 4,4′-diaminodiphenyl sulfide; 3,4′-oxydianiline; 2,2-bis(4-(4-aminophenoxy)phenyl)propane; 1,3-bis(4-aminophenoxy)benzene; 4,4′-bis(4-aminophenoxy)bipheny 1; 4,4′-diamino-3,3′-dihydroxybiphenyl; 4,4′-diamino-3,3′-dimethylbiphenyl; 4, 4′-diamino-3,3′-dimethoxy biphenyl; bisaniline M; bisaniline P; 9,9-bis(4-aminophenyl)fluorene; o-tolidine sulfone; methylene bis(anthranilic acid); 1,3-bis(4-aminophenoxy)-2,2-dimethylpropane; 1,3-bis(4-aminophenoxy propane; 1,4-bis(-aminophenoxy)butane; 1,5-bis(4-aminophenoxy)butane; 2,3,5,6-tetramethyl-1,4-phenylenediamine; 3,3′, 5,5′-tetramehylbenzidine; 4,4′-diaminobenzanilide; 2,2-bis(4-aminophenyl)hexafluoropropane; polyoxyalkylenediamines; 1,3-cyclohexanebis(methy 1 amine); mxylylenediamine; p-xylylenediamine; bis(4-amino-3-methylcyclohexyl)methane; 1,2-bis(2-aminoethoxy)ethane; and 3(4),8(9)-bis(aminomethyl)tricyclo(5.2.1.0^{2,6})decane.

In some embodiments, the diamine is 4,4′-methylenebis(2,6-diethylaniline); bisaniline-P; tricyclodecane diamine (TCD-diamine); 2,2-bis[4-(4-aminophenoxy)phenyl] hexafluoropropane; a fatty (e.g. dimer) diamine such as PRIAMINE™ 1075 or PRIAMINE™ 1074; or a combination thereof.

In some embodiments, combinations of diamines are utilized. Thus, the polyimide comprises reactions products of at least two different amines. For example, the repeat unit may comprise the reaction product of one diamine and the endcapping group may comprise a different diamine.

Suitable anhydrides include for example bisphenol-A-dianhydride (e.g. 4,4′-(4,4′-isopropylidenediphenoxy)bis(phthalic anhydride); biphenyl tetracarboxylic dianhydride; pyromellitic dianhydride; maleic anhydride; polybutadiene-graft-maleic anhydride; polyethylene-graft-maleic anhydride; polyethylene-alt-maleic anhydride; polymaleic anhydride-alt-1-octadecene; polypropylene-graft-maleic anhydride; poly(styrene-co-maleic anhydride); maleic anhydride; succinic anhydride; 1,2,3,4-cyclobutene tetracarboxylic dianhydride; 1,4,5,8-naphthalenetetracarboxylic dianhydride; 3,4,9,10-perylenentetracarboxylic dianhydride; bicyclo(2.2.2)oct-7-ene-2,3,5,6-tetracarboxylic dianhydride; diethylenetriaminepentaacetic dianhydride; ethylenediaminetetraacetic dianhydride; 3,3′, 4,4′-benzophenone tetracarboxylic dianhydride; 3,3′, 4,4′-biphenyl tetracarboxylic dianhydride; 4,4′-oxydiphthalic anhydride; 3,3′, 4,4′-diphenylsulfone tetracarboxylic dianhydride; 2,2′-bis(3,4-dicarboxyphenyl)hexafluoropropane dianhydride; 4,4′-bisphenol A diphthalic anhydride; 5-(2,5-dioxytetrahydro)-3-methyl-3-cyclohexene-1,2-dicarboxylic anhydride; ethylene glycol bis(trimellitic anhydride); hydroquinone diphthalic anhydride; allylnadic anhydride; 2-octen-1-ylsuccinic anhydride; phthalic anhydride; 1,2,3,6-tetrahydrophthalic anhydride; 3,4,5,6-tetrahydrophthalic anhydride;1,8-naphthalic anhydride; glutaric anhydride; dodecenylsuccinic anhydride; hexadecenylsuccinic anhydride; hexahydrophthalic anhydride; methylhexahydrophthalic anhydride; and tetradecenylsuccinic anhydride.

In some embodiments, the anhydride is bisphenol-A-dianhydride; biphenyl tetracarboxylic dianhydride; pyromellitic dianhydride; maleic anhydride; or a combination thereof.

In some embodiments, combinations of anhydrides are utilized. Thus, the polyimide comprises reactions products of two different anhydrides. For example, the repeat unit may comprise the reaction product of one anhydride and the endcapping group may comprise a maleic anhydride.

Maleimide terminated polyimides are commercially available. Some representative maleimide terminated polyimides are depicted in WO2021/113415; incorporated herein by reference.

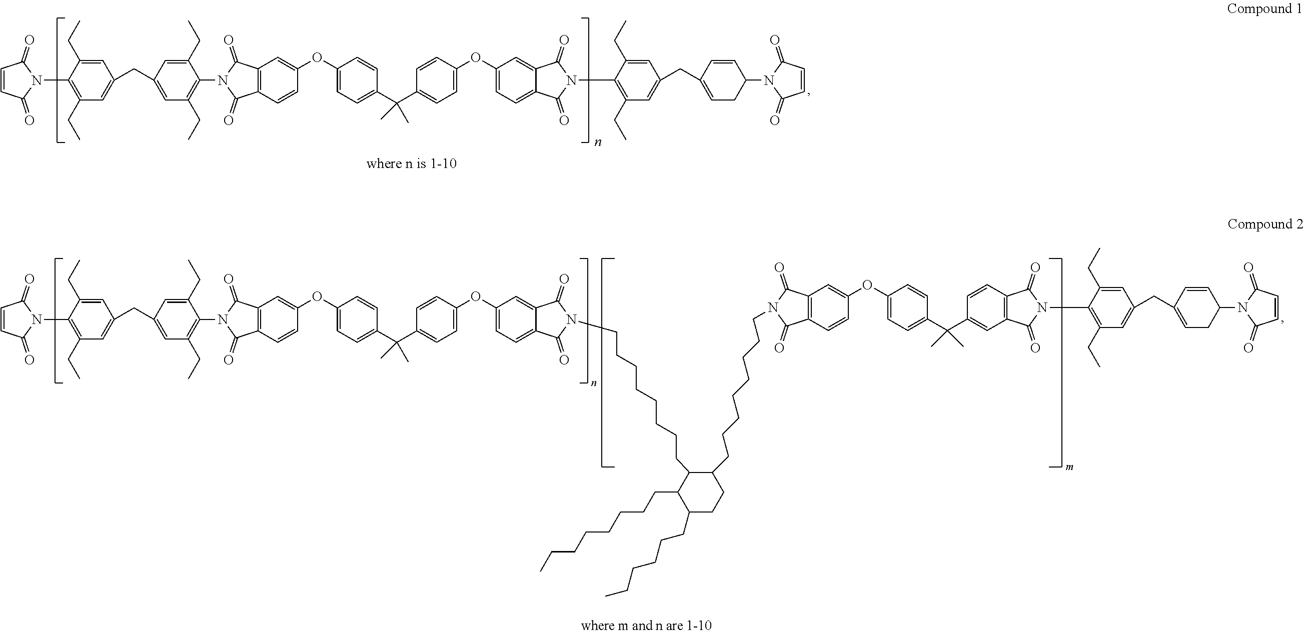

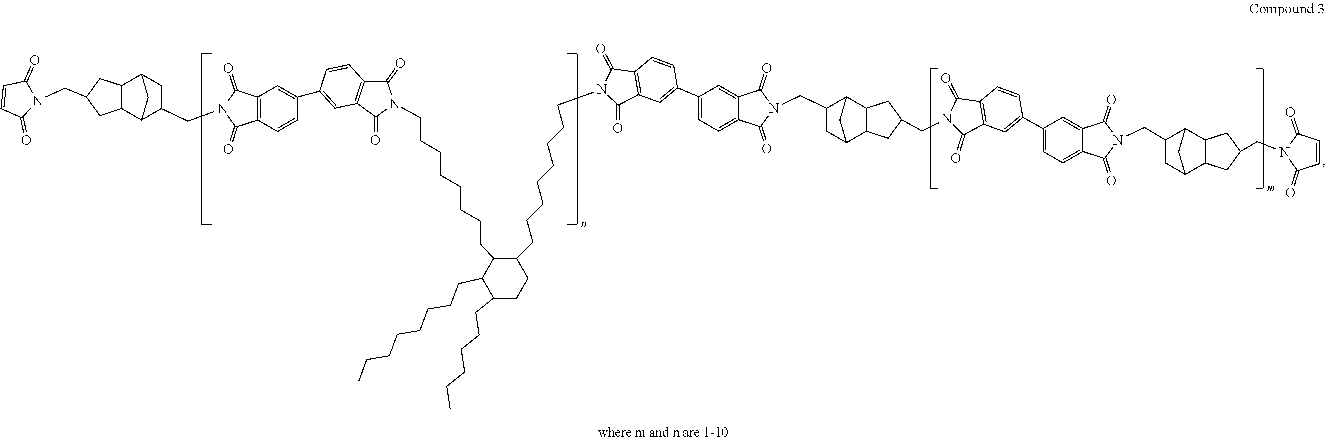

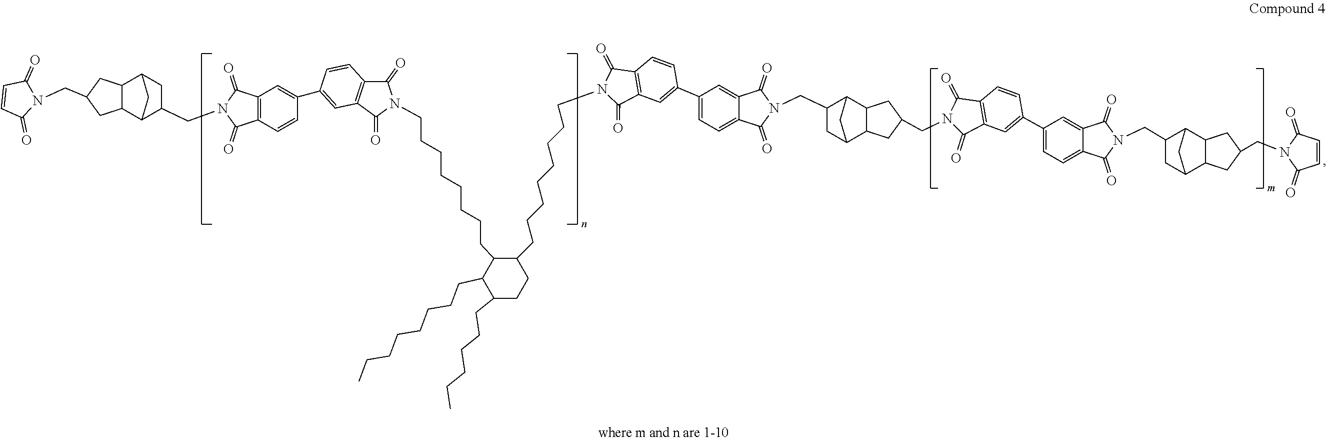

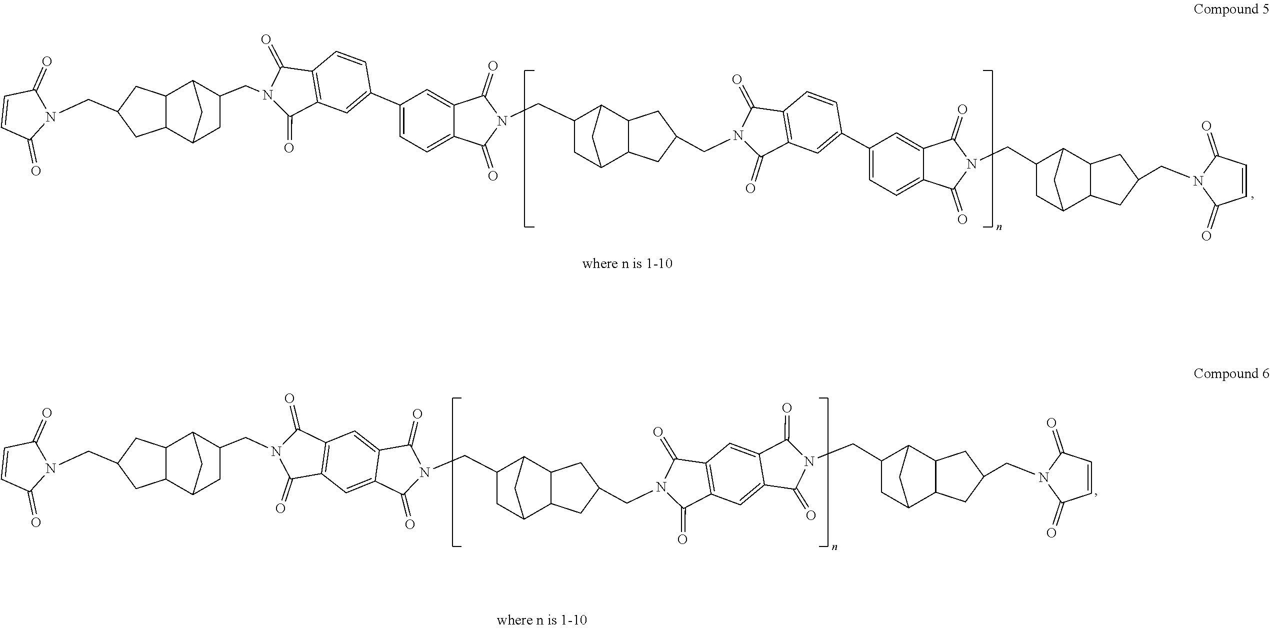

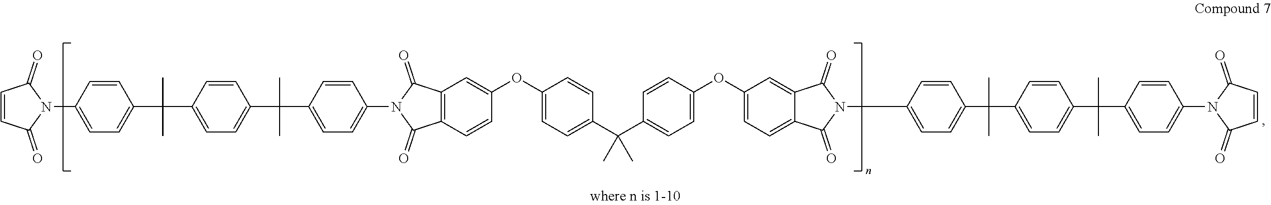

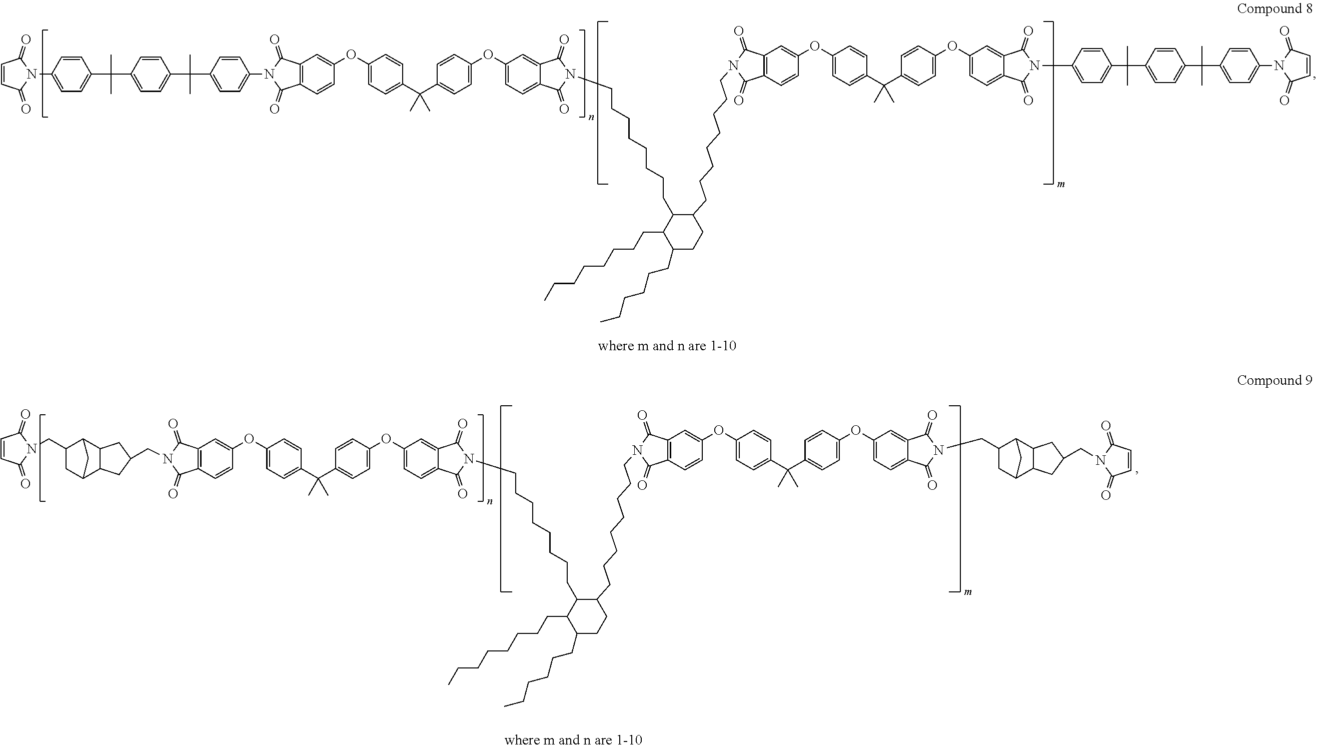

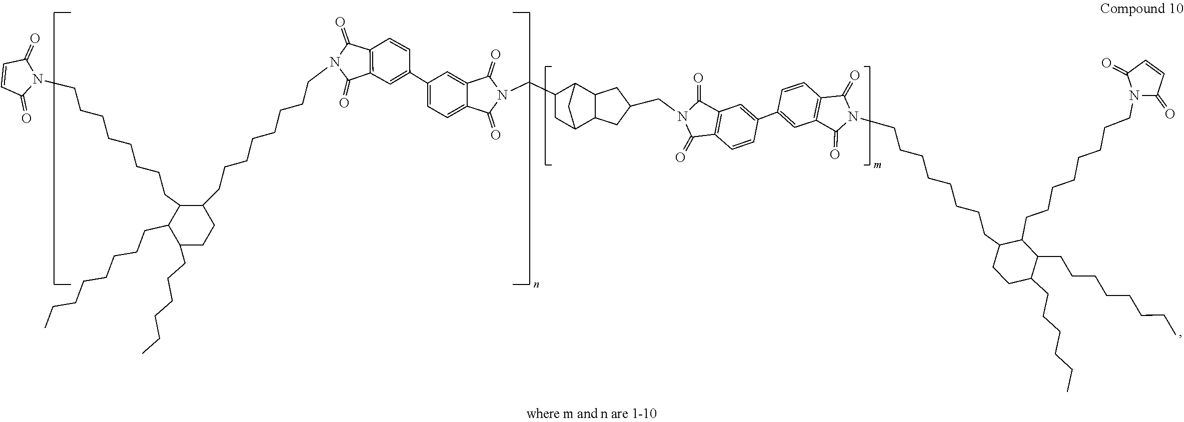

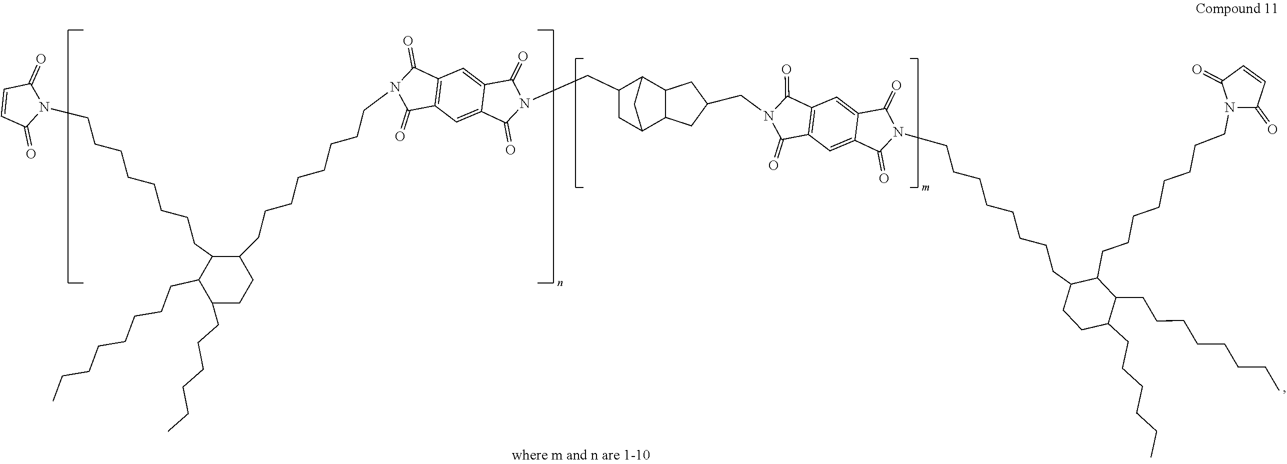

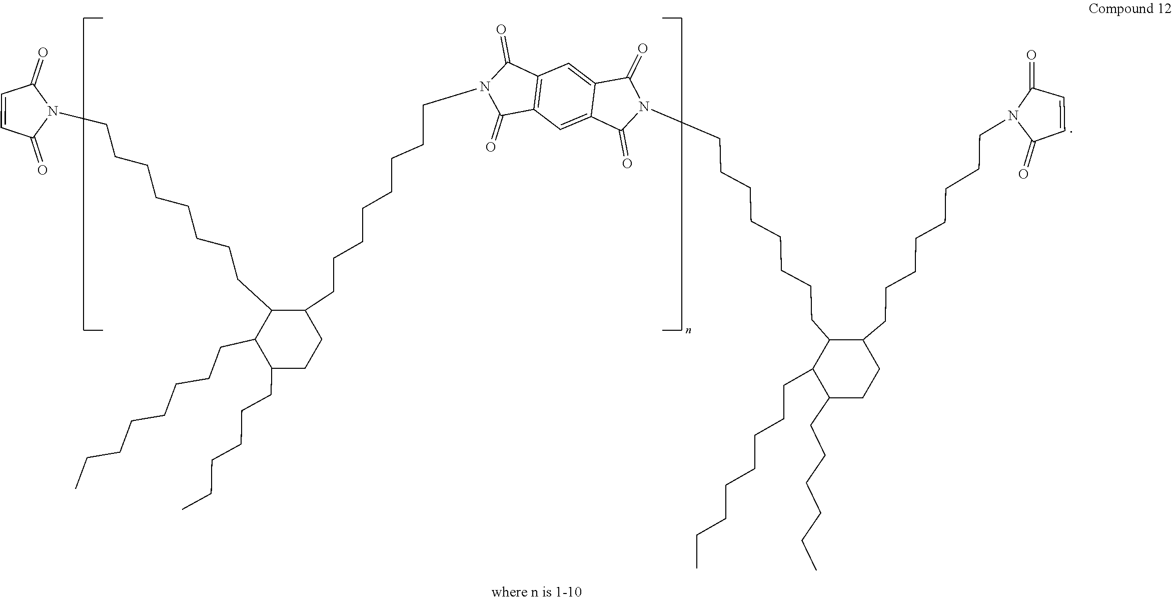

In some embodiments, the adhesive composition comprises a high Tg maleimide terminated polyimide such as depicted by Compounds 1 and 5-7, wherein R comprises an aromatic or cycloaliphatic group. Any one or combination of such compounds may be utilized. In some embodiments, adhesive composition can further comprise polyphenylene ether (PPE).

The glass transition temperature, Tg, of the maleimide terminated polyimides lacking a fatty diamine is typically greater than 170° C., 175, 180, 195, 190, 200° C. The Tg is typically no greater than about 210° C. However, the Tg of the adhesive can be increased by including other (e.g. aromatic) maleimide capped compounds having a high Tg.

In some embodiments, the adhesive composition comprises a lower Tg maleimide terminated polyimide, such as depicted by Compounds 3 and 8-12, wherein R comprises an aliphatic moiety comprising 4-60 carbon atoms. In this embodiment, the melt temperature of the maleimide terminated polyimide and adhesive composition can be less than 100, 90 or 80° C.

The adhesive composition typically comprises up to 5, 10, 15, 20, 25, or 30 wt. % of moieties comprising an aliphatic moiety comprising 4-60 carbon atoms. When the content is too high, the peel values to copper can be low. The aliphatic moiety can be saturated, as depicted in the above compounds, or may comprise ethylenic unsaturation. The aliphatic moiety may be linear or branched and may comprise a cycloaliphatic moiety. The aliphatic moiety is typically the reaction product of a fatty acid, fatty acid anhydride, or fatty diamine; including dimers thereof. The aliphatic moiety is typically divalent (e.g. derived from a dianhydride or diamine). In some embodiments, the aliphatic moiety comprises at least 6, 8, 10, 12, 14, 16, 18, 20, 24, or greater than 24 carbon atoms. In some embodiments, the aliphatic moiety comprises less than 60, 50, or 40 carbon atoms. This moiety is typically derived from utilizing a maleimide terminated polyimide, such as depicted by Compounds 3 and 8-12, wherein R comprises an aliphatic moiety comprising 4-60 carbon atoms. However, this moiety can also be derived from use of a maleimide terminated compound with such moiety and/or by use of a diamine with such moiety.

The physical properties of various maleimide terminated polyimides is reported in literature (e.g. previously cite WO20121113415). The maleimide terminated polyimide typically has a molecular weight of at least 2,000; 4,000, 6,000, 8,000 or 10,000 Daltons. The molecular weight is typically no greater than 25,000 Daltons. In some embodiments, the molecular weight is no greater than 20,000; 15,000; 10,000 or 5,000 Daltons.

The glass transition temperature, Tg, of the maleimide terminated polyimides comprising fatty diamine moieties is typically less than 170° C., 160, 150, 140, 130, 120° C. The Tg is typically at least 50, 75, or 100° C. Thus, lower concentrations of such moieties is amenable to adhesive compositions with higher Tg.

The Coefficient of Thermal Expansion (CTE) of the cured film of maleimide terminated polyimides can be less than 50 or 25 ppm/° C. The Dielectric Constant (Dk) @20 GHz of the cured film of maleimide terminated polyimides can be less than 2.7, 2.6, 2.5, 2.4, 2.3 or 2.2. The Dissipation Factor (Df) @20 GHz of the cured film can be less than 0.0080, 0.0070, 0.0060, 0.0050, 0.0040, 0.0030, or 0.0020.

The adhesive composition (e.g., of the article and method) typically comprises at least 50, 55, 60, 65, 70, 75, 80, 85, 90, 95, or 98 wt. % of maleimide terminated polyimide based on the total amount of reactive organic components (i.e. excluding filler). In some embodiments, the adhesive composition comprises at least 50, 55, 60, 65, 70, 75, 80, 85, 90, 95, or 98 wt. % of maleimide terminated polyimide wherein R comprises an aliphatic moiety comprising 4-60 carbon atoms, such as depicted by Compounds 3 and 8-12.

In some embodiments, the amount of maleimide terminated polyimide is no greater than 99, 95, 90, 85, 80, 75, 70, 65, 60 or 50 wt. % based on the total amount of reactive organic components (i.e. excluding filler). For example, when the maleimide terminated polyimide lacks an aliphatic moiety comprising 4-60 carbon atoms, the adhesive composition may comprise a higher concentration of maleimide and/or diamine compounds having such moiety. When the adhesive composition has a sufficiently high concentration of maleimide terminated polyimides, the adhesive composition can have a Tg, CTE, and dielectric properties in the same range as the maleimide terminated polyimides in combination with improved adhesion.

In some embodiments, the adhesive composition comprises maleimide terminate compounds. In some embodiments, such components comprise at least two maleimide end groups bonded to an aliphatic moiety comprising 4-60 carbon atoms, as described above.

One representative compound, reported to have a molecular weight of 689 Da and a glass transition temperature of 20° C. is depicted as follows:

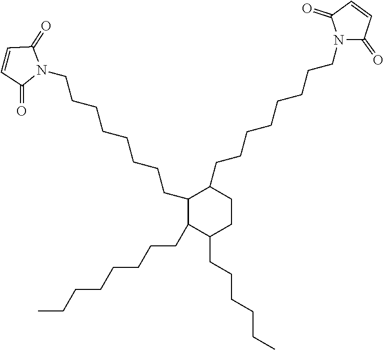 [SMILES: CCCCCCCCC1C(CCCCCC)CCC(CCCCCCCCN2C(=O)C=CC2=O)C1CCCCCCCCN1C(=O)C=CC1=O]

Other compounds include:

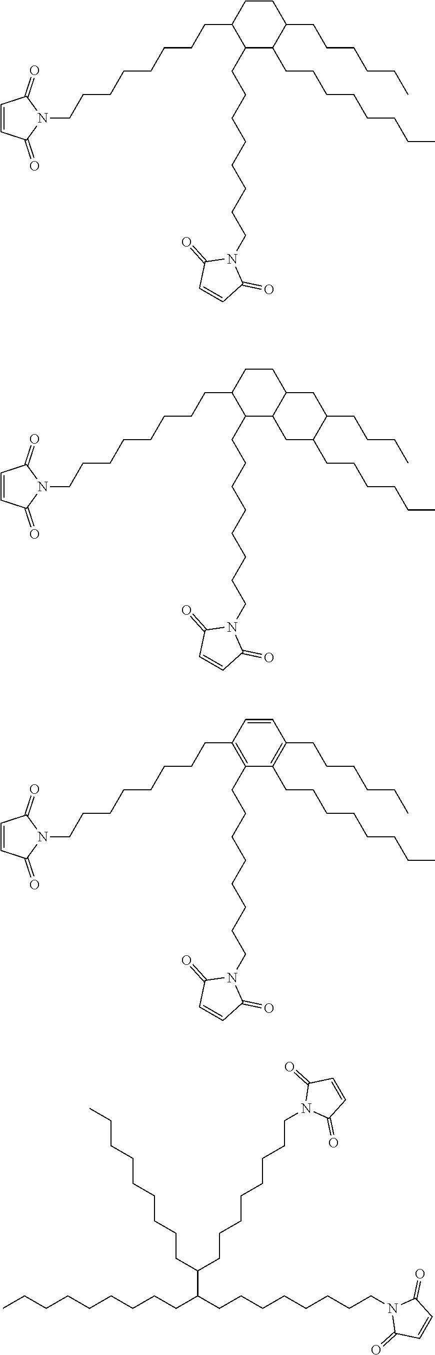

Notably the aliphatic moiety of these compounds can be saturated or partially unsaturated as described above.

Another representative maleimide terminated compound, reported to have a Tg of 229° C. is as follows

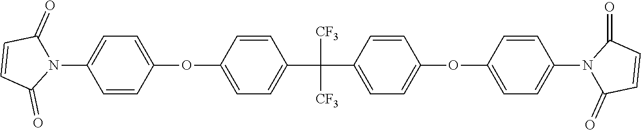 [SMILES: O=C1C=CC(=O)N1c1ccc(Oc2ccc(C(c3ccc(Oc4ccc(N5C(=O)C=CC5=O)cc4)cc3)(C(F)(F)F)C(F)(F)F)cc2)cc1]

Other representative compounds include:

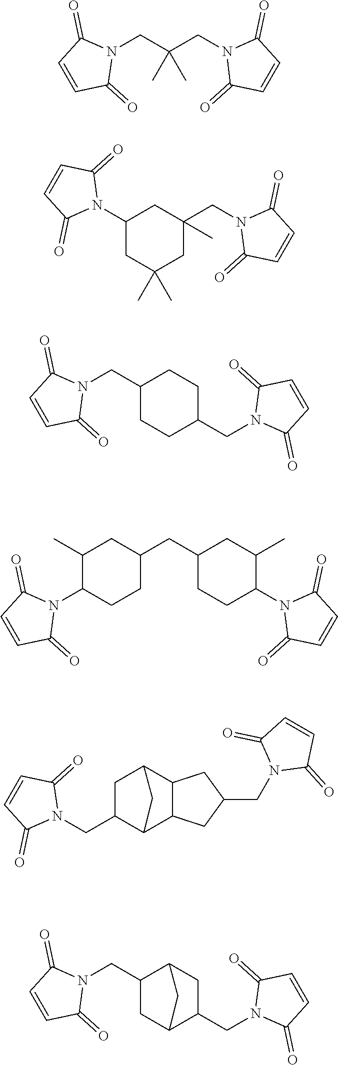

Other maleimide terminated polyimides are known in the literature, such as described in WO2017/002748; incorporated herein by reference.

In some embodiments, the adhesive composition further comprises polyether moieties. Such polyether moieties are typically the reaction product of an amine compound, as will subsequently be described. However, the adhesive composition may comprise polyether moieties by utilizing a polyether diamine during the synthesis of the maleimide terminated polyimide. Some representative compounds are as follows:

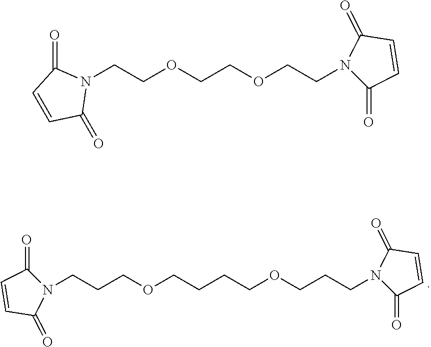 [SMILES: O=C1C=CC(=O)N1CCOCCOCCN1C(=O)C=CC1=O ; O=C1C=CC(=O)N1CCCOCCCCOCCCN1C(=O)C=CC1=O]

In yet another embodiment, the adhesive composition may comprise polyether moieties by utilizing a polyether maleimide compound, such as depicted above. The adhesive composition may comprise up to 5, 10, or 15 wt. % of polyether moieties, based on the total amount of reactive components. When low Dk and Df values are desired the total amount of polyether moieties is typically no greater than 5, 4, or 3 wt. % of the adhesive composition. When the amount of polyether is too high, the Dk and Df values can increase.

### Amine Compound

The composition (e.g. of the articles and method) comprise an amine compound. Amine compounds comprise at least one amine group and more typically two or more amine groups. The amine compound may comprise amine groups that include a primary amine, a secondary amine, a tertiary amine, or a combination thereof. The amine compound may be aliphatic or aromatic. In some embodiments, the amine compound comprises at least 3, 4, 5, or 6 amine groups. In some embodiments, the amine compound comprises no greater than 6, 5, 4, 3, or 2 amine groups. Amine compounds can be utilized to provide a crosslinked layer by (e.g. thermally) curing the maleimide moieties of the polyimide resin thereof. As illustrated by the forthcoming examples, the presence of the amine compound(s) or reaction product thereof can provide good initial adhesion to metallic substrates, such as copper and good adhesion to insulating resin layers such an epoxy resin.

In some embodiments, the adhesive composition comprises a polyether amine compound. Such compounds comprise a polyether backbone and two or more amine groups. The polyether backbone typically comprises repeat unit of C2-C4 polyalkylene oxides. The number of repeat units (represented by n, x, y, z of the representative compounds below) typically averages at least 2, 3, 4, or 5. In some embodiments, the number of repeat units averages at least 10, 20, 30, 40, 50. In some embodiments, the number of repeat units averages is no greater than 100, 90, 80, 70, 60, 50, 40, 30, 20, or 10. Typical polyalkylene oxides include polyethylene oxide, polypropylene oxide, or mixtures thereof. In some embodiments, the molecular weight of the polyether multi-amine is less than 1000, 750, or 500 g/mole. Some representative compounds are depicted as follows:

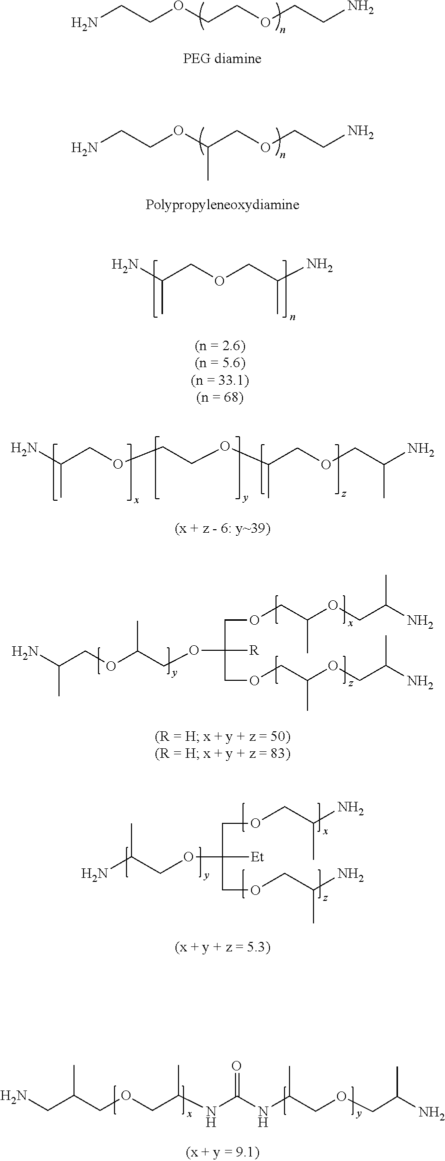

In some embodiments, the adhesive composition comprises an aliphatic diamine comprising an aliphatic moiety having 4-60 carbon atoms (e.g. derived from a fatty diamine) such as PRIAMINE™ 1071, PRIAMINE™ 1075 or PRIAMINE™ 1074. When the maleimide terminated polyamide comprises an insufficient amount of such aliphatic moieties, utilizing such diamine can increase the concentration of aliphatic moieties of the adhesive.

The structure of such aliphatic (fatty dimer) diamines is depicted as follows:

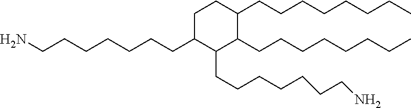 [SMILES: CCCCCCCCC1CCC(CCCCCCCN)C(CCCCCCCN)C1CCCCCCCC]

PRIAMINE™ 1074 comprises 99% dimer diamine. PRIAMINE™ 1075 comprises greater than 99% dimer diamine. Notably, such fatty dimer diamines are highly compatible with polyimide resin comprising maleimide moieties prepared from these same diamines. Unlike the polyether amine compounds, such aliphatic diamine (e.g., derived from a fatty diamine) lacks ether moieties, as well as other oxygen containing moieties such as carbonyl, ester, and hydroxyl.

Both the polyether amine compounds and aliphatic (fatty dimer) diamines are aliphatic, lacking an aromatic moiety. The aliphatic (fatty dimer) diamines comprise an aliphatic (e.g., hydrocarbon) moiety comprising 4-60 carbon atoms. The aliphatic (e.g. hydrocarbon) moiety of can be alkyl, alkylene, alkene, alkyne, or combinations thereof. In some embodiments, the hydrocarbon moiety comprises at least 6 or 8 carbon atoms. In some embodiments, the hydrocarbon moiety comprises no greater than 50, 40, 30, or 24 carbon atoms. In some embodiments, the hydrocarbon moiety comprises no greater than 22, 20, 18, 16, 14, or 12 carbon atoms. The aliphatic (e.g., hydrocarbon) moiety may be straight-chained, branched, and may comprise cycloaliphatic groups. In some embodiments, the compound comprises at least two, three, or four aliphatic moieties (e.g., hydrocarbon chains). For example, the PRIAMINE compounds may be described has having a 6-membered cycloaliphatic hydrocarbon, covalently bonded to 4 (straight-chain) hydrocarbons, two of which are terminated with (e.g., primary) amines. Such amine compound(s) comprise 94 wt. % methylene (CH₂) and/or methine (CH).

The adhesive composition comprises an amine compound or compounds, including reaction products thereof in an amount of at least 0.5, 1, 2, 3, 4, or 5 wt. % based on the total amount of reactive components. In some embodiments, the adhesive composition comprises no greater than 15 or 10 wt. % of amine compounds. In some embodiments, the adhesive composition comprises less than 10, 9, 8, 7, 6, 5, 4, or 3 wt. % of amine compounds. Typically the minimum amount of amine compound that can provide the desired 90 and/or 180 degree peel adhesion or crosshatch adhesion is utilized. The preferred amount of amine compound can vary depending on the compound.

### Additional Components

The adhesive composition (e.g. of the article or method) may further comprise other components including for example a thermal initiator, an oligomer (e.g. polyimide oligomer), inorganic filler, epoxy resin, reactive diluent, oxidizing agent, and combinations thereof.

The adhesive composition is typically a one-part adhesive component comprising all the requisite and optional components combined with each other. However, it is also contemplated that some of the components may be added immediately prior to use. For example, the composition may have a longer shelf life when the amine compound and/or thermal initiator are added immediately prior to use. It is also contemplated that the adhesive composition is a two-part adhesive wherein the combination of first and second part comprises all the requisite and optional components. For example, the first part may be applied to the conductive metallic substrate and the second part applied to the insulating resin layer. In these embodiments, the first and second part are combined during manufacture of the article.

The adhesive composition typically comprises a thermal free radical initiator such as an organoperoxide. Representative compounds include dialkyl peroxides and dicumyl peroxide available under the trade designation LUPEROX from Arkema.

In typical embodiments, the adhesive composition may lack triazine compound curatives. In this embodiment, a bismaleimide-triazine (BT) resin is not formed.

The adhesive composition may optionally comprise an epoxy resin. Various aromatic and aliphatic epoxy resins are known in the art. When present, the amount of epoxy resin is less than the amount of polyimide. Thus, the epoxy resin can be present in an amount less than 50, 40, 30, wt. % of the reactive components. In some embodiments, the adhesive composition comprises less than 25, 15, 10, 5, 4, 3, 2, 1, 0.5, or zero epoxy resin. Small amounts of epoxy resin may be beneficial to adjust the properties or co-cure with the B-stage epoxy pre-preg. In such embodiments, the amount of epoxy resin is typically at least 1, 2, 3, 4, 5, 10, 15, or 20 wt. % of the reactive components.

The adhesive composition optionally comprises a reactive diluent. Representative reactive diluents include for example acrylates, methacrylates, styrenics, isopropenylbenzene derivatives, acrylamides, methacrylamides, maleates, cinnamates, vinyl pyridine; aldehydes; episulfides, cyclosiloxanes, oxetanes, lactones, acrylonitrile, cyanoacrylates, vinyl ketones, acrolein, vinyl sulfones, vinyl sulfoxides, vinyl silanes, glycidol, isocyanates and combinations thereof. The amount of reactive diluent can range from 0 to 30 wt. % of the reactive components. Minimizing the reactive diluent can maximize the concentration of polyimide, which in turn can contribute to the adhesive having suitable dielectric properties.

In some embodiments, the adhesive composition comprises a filler including for example (e.g., fumed) silica, alumina, titanium dioxide, calcium carbonate, graphite, boron nitride, fluoropolymers (e.g. fluoro-resin) such as polytetrafluoroethylene, and mixtures thereof. In some embodiments, the filler is an inorganic filler, such as fumed silica rather than a fluoropolymer. In this embodiment, the adhesive composition may lack fluoro-resin fillers. When present, the amount of (e.g., inorganic) filler is typically less than 50, 45, 40, 35, or 30 wt. % of the total composition. In some embodiments, the amount of (e.g., inorganic) filler is at least 5, 10, 15, 20, 25, or 30 wt. % of the total composition. The inclusion of (e.g. silica) filler can be amenable to reducing the dielectric constant, but when the concentration is too high can be detrimental to adhesion.

The filler or composition may optionally comprise a silane coupling agent. For example, it is common to apply a silane coupling agent to an inorganic filler as a surface treatment. Various silane coupling agents are known including amino silanes and epoxy silane. In typical embodiments, the amine compound that contributes to the improved adhesion, such as the polyether diamine and triamine compounds described above, lacks silane moieties and thus is not an amino silane compound. Notably good adhesion can be obtained in the absence of the adhesive composition comprising an amino silane compound. However, it is also contemplated that amino silane can be used in combination with the amino compounds described above.

### Methods of Making Articles and Component Thereof

In one embodiment, the method of making an (e.g., electronic component) comprises providing a conductive metallic substrate; applying the (e,g., adhesive or coating) composition as described herein to the conductive metallic substrate; and curing the composition.

The adhesive composition can be used in various methods of bonding. The method generally comprises providing a first substrate, such as a conductive metallic substrate. The method further comprising providing a second substrate or layer, such as an insulating resin layer. The method further comprises providing an adhesive layer, as described herein, between the first substrate and second substrate or layer.

In some embodiments, a single layer of the adhesive is applied to the first (e.g., conductive metallic) substrate. In other embodiments, a single layer of the adhesive is applied to the second substrate (e.g., insulating resin layer). Although it is convenient to apply a single layer of adhesive, wherein the adhesive comprises all the requisite components, two-part or multiple layers of the adhesive composition are also contemplated. For example, an adhesive precursor comprising the amine compound may be applied to the first (e.g., conductive metallic) substrate and an adhesive precursor comprising the polyimide with maleimide moieties applied to the second substrate (e.g., insulating resin layer). The adhesive composition comprising both components is formed by contacting the adhesive precursors with each other.

In some embodiments, the polyimide with maleimide moieties, amine compound, and other components of the adhesive are dissolved in a solvent such as a hydrocarbon solvent, an ester, an ether, or a ketone solvent. In some embodiments, the components of the adhesive are dissolved in a mixture of two or more solvents. The hydrocarbon solvent can be pentane, hexane, heptane, cyclohexane, benzene, toluene, xylene, petroleum ether, or kerosene. The ester solvent can be methyl acetate, ethyl acetate, propyl acetate or butyl acetate. The ketone solvent can be acetone, methyl ethyl ketone, methyl propyl ketone, 3-pentanone, cyclopentanone, or cyclohexanone. The ether solvent can be diethyl ether, methyl tert-butyl ether, tetrahydrofuran, 2-methyl tetrahydrofuran, 1,3-dioxolane, 1,4-dioxane, 1,2-dimethoxy ethane, or tetrahydropyran. In some embodiments, the solvent is a cyclic molecule containing at least one oxygen atom. This solvent-based adhesive can be applied to a substrate or substrates.

In one embodiment, the adhesive composition in solvent may be applied (e.g., doctor bladed) onto a continuous moving substrate (e.g., thin copper sheet or prepreg) on a (e.g., heated) conveyor belt. On a continuous line, a second substrate (e.g., sheet of copper or prepreg) is applied on top of the adhesive followed by lamination between hot rollers to form a 3-layer laminate.

In other embodiments, the solvent-based adhesive can also be coated onto a release (e.g., PET) film, dried, and would into rolls forming a transfer tape/film. The rolls of polyimide are then cut to size and sandwiched between (e.g., copper foil) substrates or between a first (e.g., copper foil) and second different (e.g., insulating) layer. The polyimide film can be laminated onto the substrate with heat and/or pressure. The adhesive composition can be thermally cured at temperatures up to about 170° C. The heat causes polymerization of the maleimide moieties with each other and crosslinking of the maleimide moieties with the amine compound. Other reactions may also occur.

### Articles and Components Thereof

Various articles can be formed from the adhesive composition including electronic articles and components thereof.

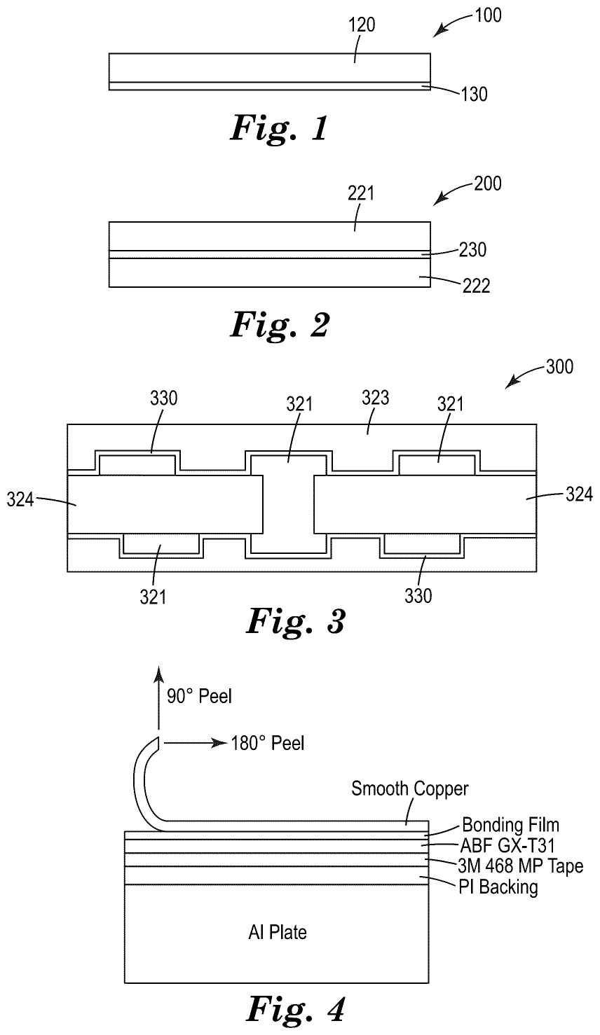

With reference to FIG. 1, various two-layer articles 100 can be formed. Such two-layer articles generally comprise a layer of the adhesive composition 130, as described herein, disposed on a substrate 120.

The adhesive layer typically has a thickness of at least 0.25, 0.5, 1, 1.5, or 2 microns. In some embodiments, the adhesive layer has a thickness no greater than 100, 50 or 25 microns.

In some embodiments, the substrate is a (e.g., PET) release liner. In this embodiment, the article may be a transfer tape or transfer film. In other embodiments, the substrate is a conductive metallic substrate (e.g., copper) or an insulating layer, such as an epoxy prepreg. In these embodiments, the articles may be components of an electronic article.

With reference to FIG. 2, various three-layer articles 200 can be formed generally comprising the adhesive layer 230 disposed between a first 221 and second substrate or layer 222.

The presently described adhesive compositions are suitable for bonding to substrates such a metal (e.g., copper) and suitable for bonding to (e.g., epoxy resin) insulating layers. Bonding to such substrates is of importance for the manufacture of electronic telecommunication articles. As used herein, electronic refers to devices using the electromagnetic spectrum (e.g. electrons, photons); whereas telecommunication is the transmission of signs, signals, messages, words, writings, images and sounds or information of any nature by wire, radio, optical or other electromagnetic systems. Electronic telecommunication articles include for example copper-clad laminates, printed circuit boards, integrated circuits, antennas, and optical cables.

The adhesive composition and transfer tape film are particularly useful for bonding to metals, such as copper, for use for copper-clad laminates, printed circuit boards (PCBs), and bonding packaged integrated circuits to a PCB.

In some embodiments, the metallic substrate (e.g. copper) has a surface roughness (Ra or Rz) of less than 10 or 5 microns. In some embodiments, the metallic substrate (e.g. copper) has a surface roughness (Ra) of less than 2, 1, 0.5, 0.1, or 0.01 microns. The adhesive may be suitable for bonding metallic substrate (e.g. copper) having an even lower surface roughness (e.g. less than 0.001. Copper having a roughness of 0.15 nm to 1.1 nm has been described in the literature. As the surface roughness decreases, the surface is more difficult to bond to. However, the adhesive can also be utilized with metallic substrates having a greater surface roughness.

A printed circuit board, or PCB, is used to mechanically support and electrically connect electronic components using conductive pathways, tracks or signal traces etched from (e.g., copper) metal sheets laminated onto a non-conductive substrate. Such boards are typically made from an insulating layer such as glass fiber reinforced (fiberglass) epoxy resin or paper-reinforced phenolic resin. The pathways for electricity are typically made from a negative photoresist. An insulating layer is disposed on the surface of the (e.g., copper) metal substrate. Portions of insulating layer are removed to form the conductive (e.g. copper) pathways. The insulting layer (e.g., photoresist) remains present, disposed between the conductive (e.g., copper) pathways of the printed circuit board. Solder is used to mount components on the surface of these boards.

Numerous PCB and IC constructions are described in the literature.

One illustrative cross-section of a portion of an integrated chip 300 is depicted in FIG. 3.

In this embodiment, an adhesive layer 330 is being utilized to bond smooth copper to a first insulating layer 323, e.g. an epoxy (e.g. build up) material. Such epoxy build up material comprises high concentration of silica and thus is difficult to bond to. The opposing surface of the copper may be bonded to a second insulting layer 324, such as an epoxy or polyimide prepeg. The adhesive may also be used to bond the copper to this second insulting layer.

Prior to (e.g., thermal) curing the adhesive can sufficiently flow and fill around copper traces up to an order of about 2 microns. After (e.g., thermal) curing, the adhesive layer can be removed along with the insulating layer using various patterning techniques including laser ablation, wet etching, dry etching, and electroless copper reception. Before and after (e.g., thermal) curing the adhesive can have high bond strength to copper and (e.g., filled) epoxy substrate.

In some embodiments, the 90 and/or 180 degree peel strength (e.g. to smooth copper) is at least 0.5, 1, 1.5, 2, 2.5, 3, 3.5, 4, 4.5 or 5 N/cm. In some embodiments, the 90 and/or 180 degree peel strength (e.g. to smooth copper) is no greater than 10 N/cm. In some embodiments, the cured adhesive layer disposed on a conductive metallic substrate has a crosshatch adhesion of at least 2B, 3B, 4B, or 5B. Adhesive compositions having low peel strength or crosshatch adhesion to copper can be used to bond other materials.

### EXAMPLES

Unless otherwise noted or apparent from the context, all parts, percentages, ratios, etc. in the Examples and the rest of the specification are by weight. Table 1, below, lists materials used in the examples and their sources.

TABLE 1
Table of materials, abbreviations, and sources.

| Material | Abbreviation | Description and Source |
|---|---|---|
| 1,1-Bis(tert-butylperoxy)-3,3,5- | Luperox ® 231 | Peroxide curative distributed by Sigma |
| trimethylcyclohexane | | Aldrich Co., St. Louis, Missouri |
| Imide extended bismaleimide | BMI-2500 | Bis-maleimide resin sold by Designer |
| oligomer | | Molecules Inc., San Diego, CA |
| Maleimide Resin | BMI-689 | Bis-maleimide resin sold by Designer |
| | | Molecules Inc |
| Hydrogenated Maleimide Resin | H-BMI-689 | Bis-maleimide resin sold by Designer |
| | | Molecules Inc |
| Bis(3-ethyl-5-methyl-4- | MeEtMaleimide | Aromatic bis-maleimide resin sold by |
| maleimidophenyl)methane | | Tokyo Chemical Industry Co., Ltd |
| Polyetheramine EC 310 | EC 310 | Trifunctional amine sold by BASF |
| | | (Baxxodur ® EC 310) with Amine |
| | | Hydrogen Equivalent Weight (AHEW) = |
| | | 81 g/Equiv. |
| Polyetheramine EC 301 | EC 301 | Difunctional amine sold by BASF |
| | | (Baxxodur® EC 301) with AHEW = |
| | | 61 g/Equiv. |
| Polyetheramine EC 311 | EC 311 | Trifunctional amine sold by BASF |
| | | (Baxxodur ® EC 311) with AHEW = |
| | | 967 g/Equiv. |
| Jeffamine ® D-205 | D 205 | Difunctional primary amine sold by |
| | | Huntsman, The Woodlands, TX. AHEW = |
| | | 58 g/Equiv. |
| Priamine 1075 | P1075 | Dimer diamine sold by Cargill (Wayzata, |
| | | MN, USA) as Priamine 1075 (high purity |
| | | grade). AHEW = 205 g/Equiv. |
| Priamine 1071 | P1071 | Dimer diamine sold by Cargill (Wayzata, |
| | | MN, USA) as Priamine 1071 (regular |
| | | grade). AHEW = 205 g/Equiv. |
| Cyclopentanone | CPN | Solvent sold by Alfa Aesar, Ward |
| | | Hill, Massachusetts, U.S. |
| ABF GX-T31 | | Build up film sold by Ajinomoto Group, |
| | | Japan |
| ADMAFINE 5SP-C8 | 5SP-C8 | 0.5 micrometer average particle size, high |
| | | purity amorphous silica with phenylsilane |
| | | surface treatment. Available from Admatechs |
| | | Co. Ltd., Japan. |
| 3M ™ Boron Nitride Cooling | CFP001 | Hexagonal boron nitride platelets with 1 |
| Filler Platelets CFP 001 | | micrometer average particle size. Available |
| | | from 3M Company, Saint Paul, MN, United |
| | | States. |
| Toluene | | Solvent acquired from Millipore Sigma, |
| | | Burlington, MA, United States |
| 1,3 Dioxolane | | Solvent acquired from Spectrum Chemical |
| | | Mfg. Corp., New Brunswick, NJ, United |
| | | States |

### EXAMPLES

### Copper Substrate Preparation

Smooth electro-deposited (ED) copper was obtained and its surface washed with sulphuric acid (5 wt. %) followed by rinsing with de-ionized water. Excess water was removed with a stream of air followed by drying in a forced-air oven at 90° C. for 5 minutes. The copper substrate was used immediately. Its surface roughness was measured to be Ra 0.01.

### Bonding Film Construction

Formulations were made up (see Tables 3, 4) and knife coated onto bare PET substrates at a wet coat thickness of 50 microns. The coated formulations were air dried followed by post drying at 60-70° C. in a forced air oven for 10 minutes.

### Test Methods

Peel testing—Sheets of the bonding films were heat transferred from their PET backings onto smooth copper utilizing a roll laminator at a temperature setpoint of about 93° C. The PET backing was removed followed by lamination of ABF GX-T31. The ABF backing was removed followed by lamination of a double sided adhesive 468MP (Sold by 3M Corporation). Finally, onto the back side of this double-sided adhesive was laminated a polyimide film The test sheets were then cut into 12.5 mm strips and laminated onto aluminum plates (see FIG. 4) and the adhesive peel value determined at the copper-bonding film interface. The peel strength was recorded on a MTS Insight Materials Testing System (Eden Prairie, MN) equipped with a load cell having a maximum capacity of 100N. The samples were tested at a rate of 12 inches per minute at an angle of either 90 or 180 degrees with respect to aluminum substrate. Separate test strips were placed in a HAST (highly accelerated stress test) chamber for 100 hours at 130° C. and 85% RH and peel strength values similarly determined.

Crosshatch Adhesion Testing—A sheet of smooth electrodeposited copper substrate (surface roughness Ra 0.01) was washed with isopropyl alcohol (IPA). 0.5 mL of formulation was pipetted onto the copper substrate and allowed to spread into a circle ˜2 cm in diameter. The coated sheet of copper was heated at 30° C. for 30 mins (slow solvent removal step), and then heated at 170° C. for 30 mins followed by 180° C. for 2 hrs (curing step). Crosshatch adhesion tests on cured samples were performed as described in ASTM D3359-09 (Standard Test Methods for Measuring Adhesion by Tape Test) where a grid of 25 squares is cut, tape and pressure via roller are applied on top of the grid, the construction is left to dwell for two mins, the tape is peeled off, and the state of the grid and the residue on the tape are inspected. A crosshatch value of 0B denotes poor adhesion (greater than 65% of grid area detached upon tape removal) through a range of 1B (35-65% lost), 2B (15-35% lost), 3B (5-15% lost), 4B (<5% lost) up to 5B which denotes the best adhesion (no detachment, no damage to scored crosshatch lines and no residue on tape upon tape removal). The term ‘zero adhesion’ denotes that it was not possible to conduct a crosshatch tape peel because the coating was detached from the substrate; hence ‘zero adhesion’ denotes worse adhesion performance than a 0B value. The crosshatch testing was conducted using 3M SCOTCH 232 Tape. Two grids/tests were run for a given formulation.

Electrical Performance—A split post dielectric resonator, ASTM 2520-21 (2021) “Standard Test Methods for Complex Permittivity (Dielectric Constant) of Solid Electrical Insulating Materials at Microwave Frequencies and Temperatures to 1650° C.”, was utilized to measure the dielectric constant and loss with an uncertainty of approximately 0.5%, and dielectric loss tangents with a resolution of 5×10−5 for film sample. All measurements were done at 9.5 GHz.

Stock solutions—Stock Solution 1: Into a mixing cup sold by Flacktek Speedmixer® was placed a solution of BMI-2500 (30 g, 40 wt. %) and H-BMI-689 (1.579 g, 40 wt. %). This was mixed at 1000 rpm in a Hauschild Speedmixer® DAC 600 FVZ mixer for two minutes to give a solution containing 12.63 g of solids. Luperox®231 (0.126 g, 1.0 wt. % with respect to total solids) was then added and the formulation agitated again on the DAC 600 FVZ mixer. Other stock solutions were made up the same manner according to the amounts of Table 2.

### Comparative Example 1 (CE-1)

An adhesive was prepared from Stock solution 4 is the manner described above. Its peel force from smooth ED copper according to setup of FIG. 4 gave a 180-degree peel force of 1.3 N/cm. Adhesion to the copper after HAST was too weak to be measured.

### Examples 1-10 (EX-1 to EX-10): Preparation of Adhesives

EXAMPLE 1: Into a mixing cup sold by Flacktek Speedmixer® was mixed the Stock Solution NN-3-0 (15 g) and EC 310 (0.122 g). This gave the adhesive of Example 1 containing the ACA (adhesive control agent) at 2 wt. % with respect to the total solids. The formulation was immediately fabricated into adhesive sheets.

EXAMPLES 2-10 were similarly made according to the amounts of Table 3, and converted into adhesive strips.

TABLE 2
Stock Solutions

| | | | | | MeEt | | |
|---|---|---|---|---|---|---|---|
| | | BMI-2500 | BMI-689 | H-BMI-689 | Maleimide | | |
| | | (40 wt. % | (40 wt. % | (40 wt. % | (40 wt. % | Total | |
| | Sample | in CPN) | in CPN) | in CPN) | in CPN) | solids | Lupero ®231 |
| | Code | (g) | (g) | (g) | (g) | (g) | (g) |
| Stock | NN-3-0 | 30 | | 1.579 | | 12.632 | 0.126 |
| Solution | | | | | | | |
| 1 | | | | | | | |
| Stock | NN-4-0 | 30 | | 3.33 | | 13.333 | 0.133 |
| Solution | | | | | | | |
| 2 | | | | | | | |
| Stock | NN-10-0 | 30 | 1.975 | | | 17.778 | 0.178 |
| Solution | | | | | | | |
| 3 | | | | | | | |
| Stock | NN-5-0 | 52.7 | | | 2.77 | 22.19 | 0.222 |
| Solution | | | | | | | |
| 4 | | | | | | | |

TABLE 3
Adhesive Formulations - (wt. % solids)

| | | | | | | | | 180° | 180° |
|---|---|---|---|---|---|---|---|---|---|
| | | | | | | | | Peel | peel |
| | | | | | | | | pre- | post- |
| | | | | | | | | HAST | HAST |
| | NN-3-0 | NN-10-0 | NN-4-0 | NN-5-0 | | ACA | ACA | peel | peel |
| Examples | (g) | (g) | (g) | (g) | ACA | (g) | wt. % | (N/cm) | (N/cm) |
| EX-1 | 15 | | | | EC310 | 0.122 | 2 | 2.75 | 1.32 |
| | (98) | | | | | | | | |
| EX-2 | 15 | | | | EC310 | 0.25 | 4 | 6.27 | 8.38 |
| | (96) | | | | | | | | |
| EX-3 | | | 15 | | EC310 | 0.122 | 2 | 1.64 | weak |
| | | | (98) | | | | | | |
| EX-4A | | 50 | | | EC310 | 0.547 | 3 | 1.24 +/− 0.08 | 0.69 +/− 0.2 |
| | | (97) | | | | | | | |
| EX-5 | | | 33.3 | | EC310 | 0.556 | 4 | 6.23 | 5.88 |
| | | | (96) | | | | | | |
| EX-6 | | | 7.5 | | EC301 | 0.0612 | 2 | 8.75 +/− 0.06 | 3.51 +/− 0.86 |
| | | | (98) | | | | | | |
| EX-7 | | | | 10 | EC301 | 0.082 | 2 | 3.15 +/− 0.69 | 4.69 +/− 0.23 |
| | | | | (98) | | | | | |
| EX-8 | | | | 10 | D-205 | 0.082 | 2 | 2.42 +/− 0.58 | 3.59 +/− 0.35 |
| | | | | (98) | | | | | |
| EX-9 | | 19 | | (98) | EC311 | 0.164 | 2 | 0.56 | weak |
| EX-10 | | 19 | | (96) | EC311 | 0.335 | 4 | 0.56 | weak |

### Examples 11-13 (EX-11 to EX-13): Evaluation of Adhesive Peel Strength at Varied BMI-689 Loading (17-33 wt. % of Total Maleimide Content)

EXAMPLE 11: Into a mixing cup sold by Flacktek Speedmixer® was charged a solution of BMI-2500 (10.0 g, 40% solids) and a solution of BMI-689 (0.91 g, 90% solids). To this was added Luperox® 231 (0.048 g) and the ACA D-230. The sealed cup was agitated for about a minute and immediately coated and dried under standard conditions. Peel testing at 180° C. was weak. Alternatively, a 90-degree peel value of 0.5 N/cm was recorded.

EXAMPLES 12 and 13 were conducted in the same manner and peel force measurements recorded (see Table 4).

TABLE 4A
Evaluation of adhesive peel strength at varied BMI-689 loading

| | BMI- | | | | | | | |
|---|---|---|---|---|---|---|---|---|
| | 2500 | BMI-689 | | | | | | |
| | (40 wt. % | (90 wt. % | BMI- | Total | | ACA | | |
| | in CPN) | in CPN) | 689 | solids | Luperox ® | D-230 | ACA | 90° Peel |
| | (g) | (g) | (wt. %) | (g) | 231 (g) | (g) | Wt % | (N/cm) |
| EX-11 | 10.0 | 0.91 | 17 | 4.819 | 0.048 | 0.073 | 1.5 | 0.5 |
| EX-12 | 9.5 | 1.407 | 25 | 5.067 | 0.051 | 0.077 | 1.5 | 1.41 |
| EX-13 | 9.0 | 1.97 | 33 | 5.373 | 0.054 | 0.082 | 1.5 | 1.2 |

TABLE 4B
Evaluation of Crosshatch Adhesion - (wt. % solids)

| | NN-10-0 | | | |
|---|---|---|---|---|
| Examples | (mL) | ACA | ACA wt. % | Crosshatch |
| EX-4A | 0.5 | EC310 | 3 | 5B |
| EX-4B | (97) | EC301 | 3 | 4B |
| EX-4C | | P1075 | 3 | 5B |
| EX-4D | | P1071 | 3 | 5B |
| COMPARATIVE | | None | 0 | 0B |
| EX-4E | | | | |

### Example 14: Electrical Performance

A container was charged with BMI-2500 (263.33 g) and cyclopentanone (1050 g). The container was sealed and agitated on a roller for about 15 hours. To this was added BMI-689 (43.9 g, 10 wt. % with respect to BMI-2500). Agitation was continued for a further 3 hours. Luperox® 231 (2.955 g, 1 wt. % with respect to total solids) followed by D-230 (4.46 g, 1.5 wt. % with respect to total solids) was added and the container again sealed and agitated for two days. The formulation was roll-to-roll slot coated and then passed through in-line drying ovens. There was obtained an adhesive coating of thickness of 10 microns. This material was laminated onto itself repeatedly to provide a free-standing film of thickness of 97 microns. This was cured with the following conditions, keeping the PET liner in pace:
(i) 30° C./30 minutes
(ii) 170° C./30 minutes
(iii) 180° C./2 hours

The PET liner was removed, and the dielectric constant and loss tangent of the film determined to be Dk 2.56, Df 0.0031 (9.5 GHz). Its 180-degree peel force according to the construction of FIG. 4 was 13+/−1 and 6.8+/−0.3 N/cm before and after HAST respectively. A cohesive failure mode was observed.

### Example 15: Electrical Performance

A 250 mL brown glass jar was charged with BMI-2500 (45.00 g) BMI-689 (5.00 g), toluene (61.75 g), and cyclopentanone (3.25 g). The jar was sealed with a PTFE lined screwcap and agitated on a roller for about 1 hour until a homogeneous solution was achieved. To the solution was added 5SP-C8 silica filler (12.50 g) and the mixture was agitated on a roller for 18 hours to disperse the particles. Luperox® 231 (1.02 g) and EC 301 (1.55 g) was added, and the jar sealed and agitated for 1 hour. The formulation was knife coated onto a bare PET liner using a knife gap of approximately 600 micrometers and dried at ambient temperature. The obtained adhesive coating was found to have thickness of approximately 200 microns. This was cured in a forced air circulating oven with the following conditions, keeping the PET liner in place:
(i) 130° C./30 minutes
(ii) 170° C./60 minutes

The PET liner was removed, and the dielectric constant and loss tangent of the film determined according to the Electrical Performance test method above. The cured film was found to have dielectric constant (Dk) of 2.67 and dielectric loss factor (Df) of 0.00220 at 25° C.

### Example 16: Electrical Performance

A 250 mL brown glass jar was charged with BMI-2500 (22.05 g) BMI-689 (2.45 g), and 1,3-dioxolane (24.50 g). The jar was sealed with a PTFE lined screwcap and agitated on a roller for about 1 hour until a homogeneous solution was achieved. To the solution was added a 25% by weight dispersion of CFP001 in toluene (17.29 g) and the mixture was agitated on a roller for 18 hours to disperse the particles. Luperox® 231 (0.25 g) and EC 301 (0.76 g) was added, and the jar sealed and agitated for 1 hour. The formulation was knife coated onto a bare PET liner using a knife gap of approximately 600 micrometers and dried at ambient temperature. The obtained adhesive coating was found to have thickness of approximately 200 microns. This was cured in a forced air circulating oven with the following conditions, keeping the PET liner in place:
(i) 130° C./30 minutes
(ii) 170° C./60 minutes

The PET liner was removed, and the dielectric constant and loss tangent of the film determined according to the Electrical Performance test method above. The cured film was found to have dielectric constant (Dk) of 2.73 and dielectric loss factor (Df) of 0.00253 at 25° C.

1. An electronic article comprising:
i) a conductive metallic substrate;
ii) an insulating resin layer; and
iii) and an adhesive layer disposed between the substrate and insulating resin layer wherein the adhesive layer comprises:
at least 50 wt. % of polyimide resin comprising maleimide moieties; and
at least 0.25 wt. % of an amine compound.

2. The electronic article of claim 1 wherein the conductive metallic substrate comprises copper.

3. The electronic article of claim 1 wherein the conductive metallic substrate comprises copper traces.

4. The electronic article of claim 1 wherein the copper has a surface roughness (Ra) of less than 2, 1, 0.5, or 0.1 microns.

5. The electronic article of claim 1 wherein the polyimide has the formula: 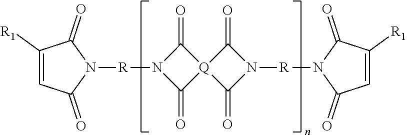
where R¹ is hydrogen or methyl; and
Q and R are independently organic linking groups.

6. The electronic article of claim 5 wherein Q is an aromatic group including a reaction product of bisphenol-A-dianhydride; biphenyl tetracarboxylic dianhydride; and pyromellitic dianhydride.

7. The electronic article of claim 1 wherein adhesive composition comprises up to 5, 10, 15, 20, 25, 30, 35, 40, 35, or 50 wt. % of moieties comprising an aliphatic moiety comprising 4-60 carbon atoms.

8. The electronic article of claim 1 wherein adhesive composition comprises up to 5, 10, or 15 wt. % of polyether moieties.

9. The electronic article of claim 1 wherein the amine compound comprises two or more amine groups and a polyether moiety.

10. The electronic article of claim 1 wherein the amine compound or reaction product thereof is uniformly distributed within the adhesive layer.

11. The electronic article of claim 1 wherein the amine compound or reaction product thereof is concentrated at an interface with the conductive metallic substrate or an interface with the insulating resin layer, or a combination thereof.

12. The electronic article of claim 1 wherein the adhesive layer further comprises an initiator including a thermal initiator, an oligomer including a polyimide oligomer, inorganic filler, and combinations thereof.

13. The electronic article of claim 1 wherein the adhesive layer comprises up to 30 wt. % of inorganic filler including siliceous filler, fused silica, and boron nitride.

14. The electronic article of claim 1 wherein the insulating resin layer comprises epoxy resin.

15. The electronic article of claim 1 wherein the insulating resin layer comprises at least 40, 50, 60 or 70 wt. % of inorganic filler including siliceous filler, fused silica, and boron nitride.

16. A component of an electronic article comprising i) and iii) or ii) and iii) according to claim 1.

17. An adhesive composition comprising:
at least 50 wt. % of polyimide resin comprising maleimide moieties; and
at least 0.25 wt. % of an amine compound comprising two or more amine groups.

18. (canceled)

19. A method of bonding comprising:
providing a conductive metallic substrate;
providing an insulating resin layer;
providing an adhesive layer between the substrate and insulating resin layer wherein
the adhesive layer comprises:
at least 50 wt. % of polyimide resin comprising maleimide moieties; and
at least 0.25 wt. % of an amine compound comprising two or more amine groups.

20-21. (canceled)

22. The electronic article of claim 1 wherein the amine compound is an aliphatic diamine comprising an aliphatic moiety having 4-60 carbon atoms.

23. The electronic article of claim 1 wherein the amine compound is derived from a fatty diamine.
